(19) United States
(12) Patent Application Publication
(10) Pub. No.: US 2026/0025243 A1
(43) Pub. Date: Jan. 22, 2026

(54) SIMULTANEOUS TRANSMISSION ON MULTI-PANEL USER EQUIPMENT (UE)

(71) Applicant: Apple Inc., Cupertino, CA (US)

(72) Inventors: Seyed Ali Akbar Fakoorian, San Diego, CA (US); Chunxuan Ye, San Diego, CA (US); Haitong Sun, Cupertino, CA (US)

(21) Appl. No.: 18/998,045

(22) PCT Filed: Aug. 10, 2023
(86) PCT No.: PCT/US2023/029961

§ 371 Date: Jan. 23, 2025

Related U.S. Application Data
(60) Provisional application No. 63/397,681, filed on Aug. 12, 2022.

(51) Int. Cl. H04L 5/00; H04B 7/0404; H04B 7/06

(52) U.S. Cl. CPC H04L 5/0044; H04B 7/0404; H04B 7/06956

(57) ABSTRACT

This disclosure describes methods and systems for Physical Uplink Shared Channel (PUSCH) layer mapping, precoding, and mapping to resource elements in multi-panel UE (STxMP) operations. A method to be performed by a user equipment involves: generating one or more codewords for simultaneous transmission on a PUSCH via two antenna panels; generating precoded and modulated sequences based on the one or more codewords, where a first subset of the generated sequences is associated with a first antenna panel, and where a second subset of the generated sequences is associated with a second antenna panel; selecting a mapping scheme for mapping the generated sequences to resource elements arranged in frequency; and mapping, using the selected mapping scheme, the generated sequences to the resource elements, where the resource elements are scheduled to be transmitted during a transmission period.

### CROSS-REFERENCE TO RELATED APPLICATIONS

The present application claims priority to U.S. Prov. App. No. 63/397,681, filed on Aug. 12, 2022, entitled “SIMULTANEOUS TRANSMISSION ON MULTI-PANEL USER EQUIPMENT (UE),” which is incorporated herein by reference in its entirety.

### BACKGROUND

Wireless communication networks provide integrated communication platforms and telecommunication services to wireless user devices, sometimes called user equipment (UE). Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

In some wireless communication networks, a base station can include or utilize one or more transmission/reception points (TRPs) to communicate with a UE. A TRP may have an antenna panel that includes one or more antenna elements, and may be located at a specific geographic location to serve a specific area. In order to increase network coverage, reliability, and data rates, some wireless communication networks support multi-TRP (m-TRP) operation. In m-TRP operation, a base station uses more than one TRP to communicate with a UE. To facilitate m-TRP operation, the UE can be a multi-panel UE that includes multiple antenna panels, with each panel having one or more antenna elements.

### SUMMARY

This disclosure describes methods and systems for Physical Uplink Shared Channel (PUSCH) layer mapping, precoding, and mapping to resource elements in multi-panel UE (STxMP) operations. In one implementation, a UE is configured with two mapping schemes for mapping coded bits to resource elements across multiple antenna panels. The first mapping scheme is based on antenna panel numbering and the second mapping scheme is based on resource element frequency. In the first mapping scheme, the UE starts with a first symbol that is allocated to the uplink transmission. In the first symbol, the UE allocates coded bits to corresponding resource elements in order of antenna panel number. The UE moves to the next symbol and performs the same mapping, and so on, until all the coded bits are mapped to all of the symbols of the uplink transmission. In the second mapping scheme, the UE starts with a first symbol that is allocated to the uplink transmission. In the first symbol, the UE allocates coded bits to the resource elements in order of frequency (irrespective of the antenna panel with which the coded bits are associated). The UE moves to the next symbol and performs the same mapping, and so on, until all the coded bits are mapped to all of the symbols of the uplink transmission.

In accordance with one aspect of the present disclosure, a method to be performed by a user equipment (UE) is disclosed. The method involves generating one or more codewords for simultaneous transmission on a PUSCH via two antenna panels; generating precoded and modulated sequences based on the one or more codewords, where a first subset of the generated sequences is associated with a first antenna panel, and where a second subset of the generated sequences is associated with a second antenna panel; selecting a mapping scheme for mapping the generated sequences to resource elements arranged in frequency; and mapping, using the selected mapping scheme, the generated sequences to the resource elements, where the resource elements are scheduled to be transmitted during a transmission period.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, method further involves transmitting, via the two antenna panels, the resource elements during the period of time.

In some implementations, selecting the mapping scheme for mapping the generated sequences to resource elements arranged in frequency involves: selecting the mapping scheme from a first mapping scheme and a second mapping scheme, where: (i) the first mapping scheme maps the precoded and modulated sequences based on an antenna panel numbering, and (ii) the second mapping scheme the precoded and modulated sequences based on frequency.

In some implementations, the first mapping scheme involves: mapping the first subset of precoded and modulated sequences to a first subset of the resource elements; and subsequently mapping the second subset of precoded and modulated sequences to a second subset of the resource elements.

In some implementations, the second mapping scheme involves mapping the first subset of precoded/modulated sequences and the second subset of precoded and modulated sequences to the resource elements in order of frequency.

In some implementations, the one or more codewords are two codewords, and where selecting the first mapping scheme or the second mapping scheme involves determining that an indication of a number of layers is per codeword; and responsively selecting the first mapping scheme.

In some implementations, the one or more codewords are two codewords, and where selecting the first mapping scheme or the second mapping scheme involves determining that an indication of a number of layers is across the two codewords; and responsively selecting the second mapping scheme.

In some implementations, selecting the first mapping scheme or the second mapping scheme is based on at least one of higher layer signaling or UE capability.

In some implementations, the resource elements are non-overlapped frequency-division-multiplexed (FDM) resources.

In some implementations, the resource elements are spatially multiplexed across the two antenna panels.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### BRIEF DESCRIPTION OF THE FIGURES

FIG. 1A and FIG. 1B illustrate example scheduling schemes for simultaneous transmission on a multi-panel UE, according to some implementations.

FIG. 2 illustrates a wireless network, according to some implementations.

FIG. 3 illustrates a transmission chain for one transport block, according to some implementations.

FIG. 4A and FIG. 4B illustrate example mapping schemes, according to some implementations.

FIG. 5A and FIG. 5B illustrate transmission chain options for transmission two transport blocks, according to some implementations.

FIG. 6 illustrates an example method, according to some implementations.

FIG. 7 illustrates a user equipment (UE), according to some implementations.

FIG. 8 illustrates an access node, according to some implementations.

Like reference numbers and designations in the various drawings indicate like elements.

### DETAILED DESCRIPTION

In line with the discussion above, there are two different modes for multi-transmission/reception point (m-TRP) operations: single downlink control information (DCI) mode and multi-DCI mode. In single DCI mode, a base station uses a single DCI to trigger a user equipment (UE) to transmit a plurality of physical uplink shared channel (PUSCH) transmissions toward multiple TRPs of the base station. In multi-DCI mode, a base station uses multiple DCI to trigger a UE to transmit a plurality of PUSCH transmissions toward multiple TRPs of the base station. In both modes, the uplink transmissions can be arranged for transmission from multiple antenna panels if the UE is a multi-panel UE. For example, a transmission from a particular antenna panel can be directed toward a corresponding TRP. Additionally, the uplink transmissions may be repetitions of the same transport block (TB). The uplink transmissions may additionally and/or alternatively be physical uplink control channel (PUCCH) transmissions.

In single-DCI mode, the PUSCH transmissions may be scheduled such that there is an overlap in time between the different transmissions. In order to facilitate simultaneous PUSCH transmissions on a multi-panel UE (STxMP), the following schemes can be used: (i) a spatial division multiplexing (SDM) scheme, (ii) a type-A frequency division multiplexing (FDM-A) scheme, (iii) a type-B frequency division multiplexing (FDM-B) scheme, and (iv) a single frequency network (SFN) scheme. In the SDM scheme, different layers or demodulation reference signal (DMRS) ports of one PUSCH transmission are separately precoded and simultaneously transmitted from different UE panels. The transmissions may overlap in time and frequency, but are transmitted in different spatial directions from different panels. In the FDM-A scheme, different portions of one PUSCH transmission are transmitted from different UE panels on non-overlapped frequency domain resources (e.g., orthogonal resources) and on the same time domain resources. In the FDM-B scheme, a plurality of repetitions of the same PUSCH transmission are transmitted from different UE panels on non-overlapped frequency domain resources and on the same time domain resources. In this scheme, the plurality of repetitions can be the same or different redundancy version (RV) of the same transport block. The SFN scheme is similar to the SDM scheme, except that the same coded symbols are transmitted across the different panels. That is, the same layers/DMRS ports of one PUSCH are transmitted from the different UE panels simultaneously. In SDM, different coded symbols are transmitted across the different panels.

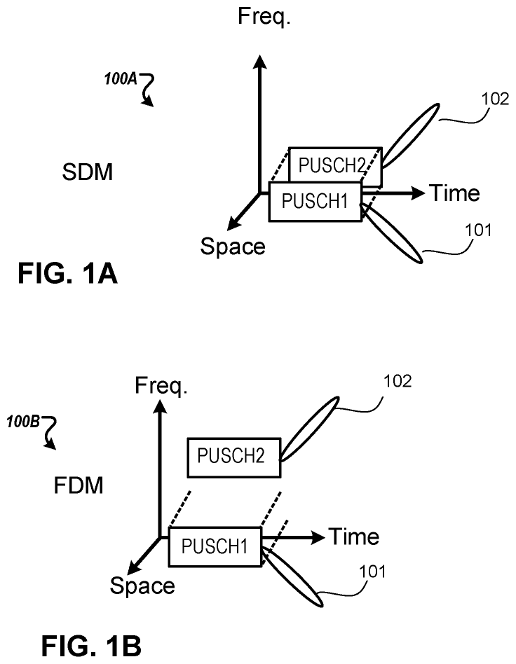

FIG. 1A and FIG. 1B illustrate example scheduling schemes 100A, 100B for simultaneous transmission on a multi-panel UE, according to some implementations. In these examples, it is assumed that a multi-panel UE (not illustrated) is scheduled to simultaneously transmit two PUSCH transmissions, labeled in the figures as PUSCH1 and PUSCH2, from respective panels. The transmission from each panel is directed toward a corresponding TRP of a serving base station.

Turning to FIG. 1A, the PUSCH transmission includes PUSCH1 and PUSCH2, which are scheduled to occur during the same transmission period. Under the SDM scheme of FIG. 1A, PUSCH1 and PUSCH2 fully overlap in time and frequency, but are spatially divided on two panels 101 and 102. Each panel transmits a beam that carries the transmission toward a corresponding TRP (not illustrated).

In FIG. 1B, the PUSCH transmission includes PUSCH1 and PUSCH2, which are scheduled to occur during the same time period. Under the FDM scheme of FIG. 1B, PUSCH1 and PUSCH2 do not overlap in frequency but are multiplexed on different frequency bands. PUSCH1 and PUSCH2 are then transmitted by the two panels 101 and 102 toward corresponding TRPs (not illustrated). If the scheme is FDM-A, then PUSCH1 and PUSCH2 are different portions of the same transport block. That is, PUSCH1 and PUSCH2 together form the entire PUSCH transmission. If the scheme is FDM-B, then repetitions of the same information (e.g., transport block) is transmitted in PUSCH1 and PUSCH2. Note that, in some scenarios, PUSCH1 and PUSCH2 can be frequency division multiplexed such that they are partially overlapping in frequency.

However, some issues related to the described PUSCH constructions for STxMP have not yet been addressed by the Third Generation Partnership Project (3GPP) technical specifications. One of these issues is related to PUSCH layer mapping, precoding, and mapping to resource elements. The existing 3GPP technical specifications assumes that only a single codeword can be transmitted at a given time by a UE. Additionally, the existing technical specifications assume that only non-overlapping PUSCHs can be transmissions. A UE operating according to these assumptions is not capable of properly utilizing STxMP operations since the assumptions do not account for STxMP features (e.g., simultaneously transmitting multiple codewords and/or simultaneously transmitting overlapping PUSCHs). More specifically, the existing technical specifications do not have mechanisms for processing multiple codewords for simultaneous transmission. As an example, the existing technical specifications do not have mechanisms for mapping multiple codewords to resource elements for simultaneous transmission from multiple panels.

This disclosure describes methods and systems for PUSCH layer mapping, precoding, and mapping to resource elements in STxMP operations. In one implementation, a UE is configured with two mapping schemes for mapping coded bits to resource elements across multiple antenna panels. The first mapping scheme is based on antenna panel numbering and the second mapping scheme is based on resource element frequency. In the first mapping scheme, the UE starts with a first symbol that is allocated to the uplink transmission. In the first symbol, the UE allocates coded bits to corresponding resource elements in order of antenna panel number. The UE moves to the next symbol and performs the same mapping, and so on, until all the coded bits are mapped to all of the symbols of the uplink transmission. In the second mapping scheme, the UE starts with a first symbol that is allocated to the uplink transmission. In the first symbol, the UE allocates coded bits to the resource elements in order of frequency (irrespective of the antenna panel with which the coded bits are associated). The UE moves to the next symbol and performs the same mapping, and so on, until all the coded bits are mapped to all of the symbols of the uplink transmission.

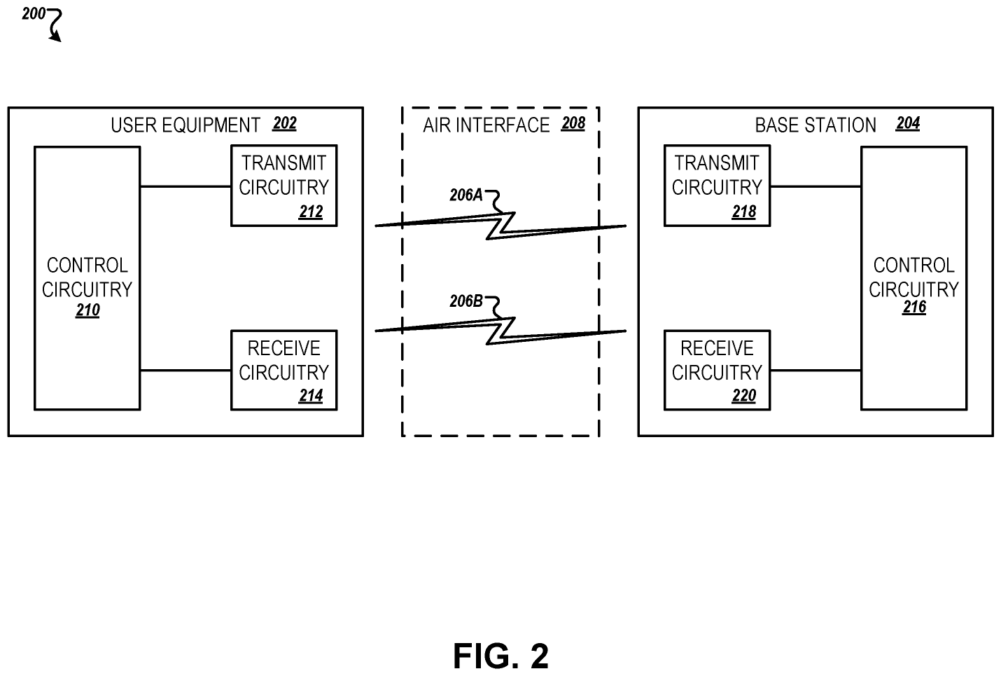

FIG. 2 illustrates a wireless network 200, according to some implementations. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 may be a Standalone (SA) network that incorporates Fifth Generation (5G) New Radio (NR) communication standards as defined by 3GPP technical specifications. In other implementations, the wireless network 200 may be a Non-Standalone (NSA) network that incorporates Long Term Evolution (LTE) and 5G NR communication standards. For example, the wireless network 200 may be a E-UTRA (Evolved Universal Terrestrial Radio Access)-NR Dual Connectivity (EN-DC) network, or a NR-EUTRA Dual Connectivity (NE-DC) network. Furthermore, other types of communication standards are possible, including future 3GPP systems (e.g., Sixth Generation [6G]) systems, Institute of Electrical and Electronics Engineers (IEEE) 802.11 technology, or the like. While aspects may be described herein using terminology commonly associated with 5G NR, aspects of the present disclosure can be applied to other systems, such as 3G, 4G, and/or systems subsequent to 5G (e.g., 6G).

In the wireless network 200, the UE 202 and any other UE in the system may be, for example, laptop computers, smartphones, tablet computers, machine-type intelligent transportation systems, or any other wireless devices with or without a user interface. In network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider, or may be the Internet. Each base station service area associated with the base station 204 is supported by antennas integrated with the base station 204. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include various combinations of application-specific circuitry and baseband circuitry. The transmit circuitry 212 and receive circuitry 214 may be adapted to transmit and receive data, respectively, and may include radio frequency (RF) circuitry or front-end module (FEM) circuitry.

In various implementations, aspects of the transmit circuitry 212, receive circuitry 214, and control circuitry 210 may be integrated in various ways to implement the operations described herein. The control circuitry 210 may be adapted or configured to perform various operations such as those described elsewhere in this disclosure related to a UE.

Additionally, the transmit circuitry 212 may transmit a plurality of multiplexed uplink physical channels. The plurality of uplink physical channels may be multiplexed according to time division multiplexing (TDM) or FDM along with carrier aggregation. The transmit circuitry 212 may be configured to receive block data from the control circuitry 210 for transmission across the air interface 208.

Additionally, the receive circuitry 214 may receive a plurality of multiplexed downlink physical channels via the air interface 208 and relay the physical channels to the control circuitry 210. The plurality of downlink physical channels may be multiplexed according to TDM or FDM along with carrier aggregation. The transmit circuitry 212 and the receive circuitry 214 may transmit and receive both control data and content data structured within data blocks that are carried by the physical channels.

FIG. 2 also illustrates the base station 204. In implementations, the base station 204 may be an NG radio access network (RAN) or a 5G RAN, an E-UTRAN, a non-terrestrial cell, or a legacy RAN. As used herein, the term “NG RAN” or the like may refer to the base station 204 that operates in an NR or 5G wireless network 200, and the term “E-UTRAN” or the like may refer to a base station 204 that operates in an LTE or 4G wireless network 200. The UE 202 utilizes connections (or channels) 206A, 206B, each of which includes a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208. The transmit circuitry 218 and receive circuitry 220 may be adapted to transmit and receive data, respectively, to any UE connected to the base station 204. The transmit circuitry 218 may transmit downlink physical channels includes of a plurality of downlink subframes. The receive circuitry 220 may receive a plurality of uplink physical channels from various UEs, including the UE 202.

In FIG. 2, the one or more channels 206A, 206B are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 202 may directly exchange communication data with another UE (not depicted) via a ProSe interface. The ProSe interface may alternatively be referred to as a sidelink (SL) interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In some implementations, the UE 202 is configured to perform simultaneous multi-panel UL (e.g., PUSCH) transmissions. The simultaneous multi-panel transmissions may be scheduled by a single DCI or multiple DCI. In simultaneous multi-panel transmissions, the transmission from each panel may be directed toward a corresponding TRP of the base station 204. The UE 202 can transmit one or more layers across the antenna panels, and can transmit one or more codewords across the antenna panels. In one example, the number of layers is up to four across all antenna panels, and the total number of codewords is up to two across all antenna panels. Other numbers of layers and codewords are also possible.

In some implementations, the UE 202 is configured to use the SDM scheme, the FDM-A scheme, the FDM-B, or the SFN scheme to schedule the simultaneous multi-panel transmissions. As described previously, in the SDM scheme, different layers of one PUSCH transmission are simultaneously transmitted from different antenna panels. In the SFN scheme, all of the same layers/DMRS ports of one PUSCH are transmitted from two different UE panels simultaneously. In the FDM-A scheme, different portions of one PUSCH transmission are transmitted from different UE panels on non-overlapping frequency domain resources. In the FDM-B scheme, repetitions of the same PUSCH transmission are transmitted from different UE panels on non-overlapping frequency domain resources.

In some implementations, the received DCI schedules an UL transmission opportunity. The UL transmission opportunity can include resource elements (e.g., time and frequency resources) allocated to the UE 202 for the UL transmission. In response to receiving the DCI, the UE 202 is configured to prepare one or more transport blocks for transmission in the UL transmission opportunity. As an example, the UE 202 can prepare one transport block for transmission. In this example, the UE 202 can use SDM, FDM-A, FDM-B, or SFN to perform the transmission as a simultaneous multi-panel transmission. As another example, the UE 202 can prepare two transport blocks for transmission. In this example, the UE 202 can also use SDM, FDM-A, FDM-B, or SFN to perform the transmission as a simultaneous multi-panel transmission.

In some implementations, the UE 202 is configured to use a transmission processing chain to prepare the one or more transport blocks for simultaneous multiple panel transmission. Among other things, the transmission processing chain maps the one or more transport blocks to the resource elements allocated for the transmission occasion. More specifically, the transmission processing chain maps coded bits of the one or more transport blocks to resource elements across multiple antenna panels of the UE. In the description below, the processing of a single transport block is described first. Then, the processing of two transport blocks is described. However, the same processing techniques can be expanded to more than two transport blocks. Additionally, in the description below, it is assumed that the UL transmission is scheduled for transmission from two antenna panels of the UE 202. However, other numbers of antenna panels are also possible.

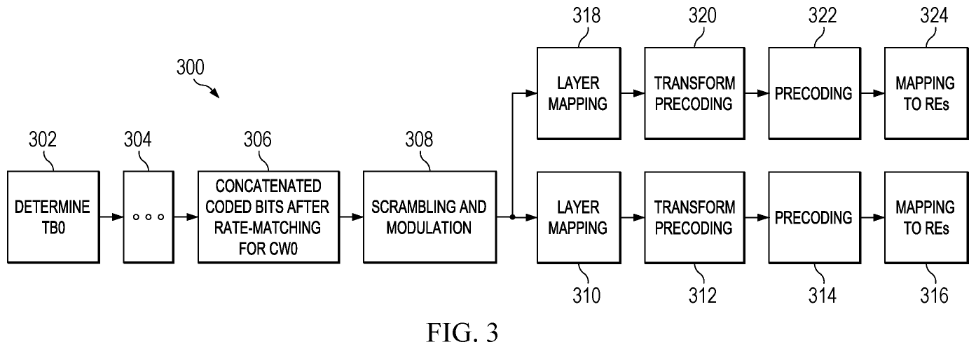

FIG. 3 illustrates a transmission chain 300 for one transport block, according to some implementations. Each of the blocks of the transmission chain 300 represent one or more processing steps. As shown by block 302, the transmission processing chain 300 includes a first step of determining the transport block (TB0) for transmission. This step is described in more detail in 3GPP TS 38.213, Section 6.1.4.2. Next, as shown by block 306, the transmission processing chain 300 includes concatenating coded bits after rate-matching for a generated codeword (CW0). Note that between blocks 302 and 306, there are several steps represented by block 304, which are described in more detail in 3GPP TS 38.212, Section 6.2. At block 308, the transmission processing chain 300 includes scrambling and modulation. This step is described in more detail in 3GPP TS 38.211, Sections 6.3.1.1-6.3.1.2. At block 310, the transmission processing chain 300 includes layer mapping, which is described in more detail in TS 38.211 Section 6.3.1.3. At block 312, the transmission processing chain 300 includes transform precoding, which is described in more detail in TS 38.211 Section 6.3.1.4. At block 314, the transmission processing chain 300 includes precoding, which is described in more detail in TS 38.211 Section 6.3.1.5. At block 316, the transmission processing chain 300 includes mapping the coded bits to resource elements.

In some implementations, and as shown in FIG. 3, the transmission chain 300 is duplicated after the scrambling and modulation step 308. The duplicated portion of the transmission chain 300, e.g., blocks 318-324, can be used in scenarios of SDM (and SFN). As previously described, SDM involves different layers or demodulation reference signal (DMRS) ports of one PUSCH transmission being separately precoded and simultaneously transmitted from different UE panels. Thus, the different layers can be mapped and precoded using blocks 310-316 and 318-326.

In some implementations, the UE 202 is configured with two mapping schemes for mapping coded bits to resource elements across multiple antenna panels. The first mapping scheme is based on antenna panel numbering and the second mapping scheme is based on resource element frequency. In the first mapping scheme, the UE 202 starts with a first symbol that is allocated to the uplink transmission. In the first symbol, the UE 202 allocates coded bits to corresponding resource elements in order of antenna panel number. More specifically, the UE 202 allocates a first subset of coded bits associated with a first antenna panel to resources of the first antenna panel, and then allocates a second subset of coded bits associated with a second antenna panel to resources of the second antenna panel, and so on, until all of the coded bits of the first symbol have been allocated across the antenna panels. The UE 202 moves to the next symbol and performs the same mapping, and so on, until all the coded bits are mapped to all of the symbols of the uplink transmission.

In the second mapping scheme, the UE 202 starts with a first symbol that is allocated to the uplink transmission. In the first symbol, the UE 202 allocates coded bits to the resource elements in order of frequency (irrespective of the antenna panel with which the coded bits are associated). For example, the UE 202 starts by mapping the coded bits associated with the lowest frequency to resources on that frequency, then maps the coded bits associated with the second lowest frequency to resources on that frequency, and so on, until all of the coded bits of the first symbol have been mapped. The UE 202 moves to the next symbol and performs the same mapping, and so on, until all the coded bits are mapped to all of the symbols of the uplink transmission.

In some implementations, the UE 202 is configured to select the mapping scheme to apply based on Radio Resource Control (RRC) signaling and/or subject to UE capability. In some implementations, the UE 202 is configured to apply either of the two mapping schemes in SDM, FDM-A, or SFN with a single codeword for transmission.

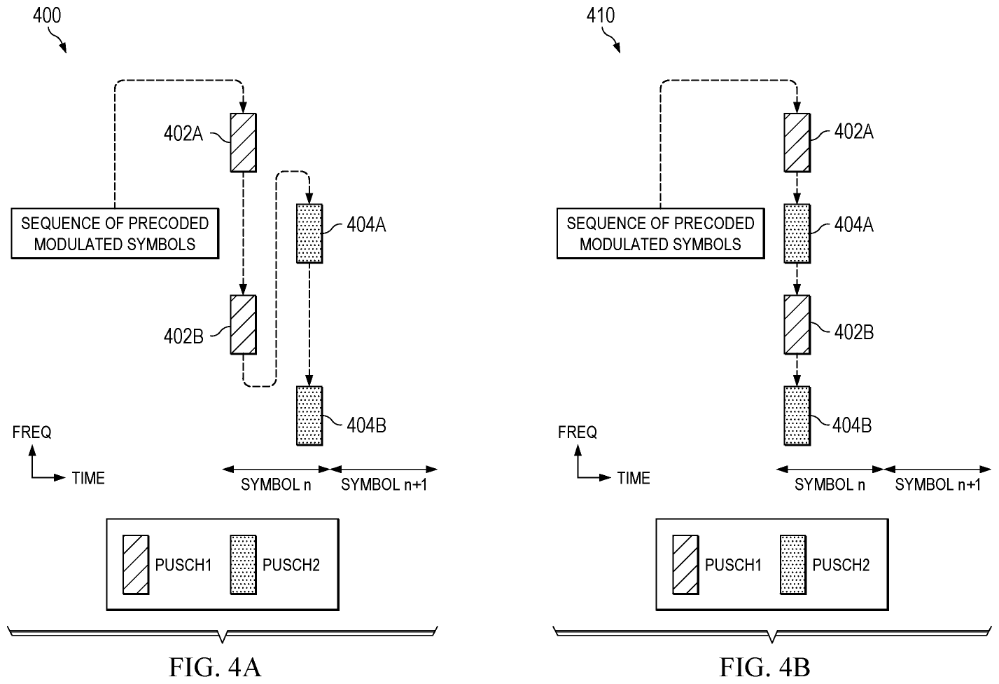

FIG. 4A and FIG. 4B illustrate example mapping schemes, according to some implementations. In particular, FIG. 4A illustrates an example 400 of the first mapping scheme based on antenna panel numbering and FIG. 4B illustrates an example 410 of the second mapping scheme based on resource element frequency. In these examples, it is assumed that a UE has generated a sequence of precoded modulated symbols that the UE will map to transmission resources allocated to the transmission opportunity. For the purposes of the examples, a first symbol in the sequence includes four resource blocks, where two resource blocks 402A, 402B are allocated to a first antenna panel of the UE and two resource blocks 404A, 404B are allocated to a second antenna panel of the UE. The resource blocks of the first antenna panel are labeled as PUSCH1 and the resource blocks of the second antenna panel are labeled as PUSCH2.

Starting with FIG. 4A, in the first mapping scheme, the UE maps the precoded modulated bits based on antenna panel numbering. In the example 400, in the first symbol “n,” the UE can map PUSCH1 first and PUSCH2 second (or vice versa), irrespective of the frequencies of PUSCH1 and PUSCH2. As shown in FIG. 4A, the UE maps the resource blocks 402A, 402B first, even though resource block 404A precedes resource block 402B in frequency. Once the UE maps resource blocks 402A, 402B, the UE then maps the resource blocks 404A, 404B. Then, the UE moves to the next symbol, “n+1,” and performs the same mapping, and so on, until all of the precoded modulated symbols have been mapped.

Turning to FIG. 4B, in the second mapping scheme, the UE maps the precoded modulated bits based on frequency. In the example 410, in the first symbol “n,” the UE maps PUSCH1 and PUSCH2 in order of frequency (e.g., from lowest frequency to highest), irrespective of the antenna panel with which the bits are associated. As shown in FIG. 4B, the UE maps the resource blocks in the following order: 402A, 404A, 402B, 404B. The UE moves to the next symbol, “n+1,” and performs the same mapping, and so on, until all of the precoded modulated symbols have been mapped.

In some implementations, the UE 202 can be configured to use one of two transmission chain options for transmission two transport blocks. In the first transmission chain option, the two transport blocks are processed using independent transmission chains. The first transmission chain option can be used when the indication of the number of layers/precoding in the received DCI is per codeword/transport block. The number of layers is also referred to as rank. In the second transmission chain option, the two transport blocks are processed using a combined transmission chain. The first transmission chain option can be used when the indication of the number of layers/precoding in the received DCI is across codewords/transport blocks. Note that in the first transmission chain option the coded symbols from each codeword span only limited frequency domain resources.

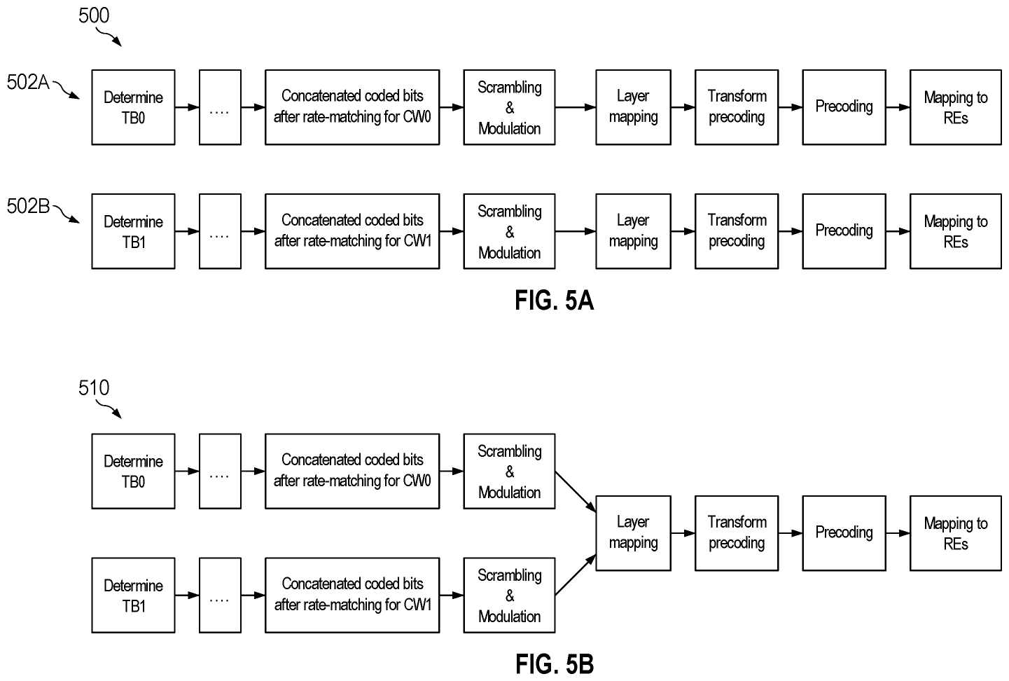

FIG. 5A and FIG. 5B illustrate transmission chain options for transmission of two transport blocks, according to some implementations. As shown in FIG. 5A, a first transmission chain option 500 includes two independent transmission chains 502A, 502B. And as shown in FIG. 5B, a second transmission chain option 510 includes a combined transmission chain 504. In the combined transmission chain 504, the two transport blocks are processed independently through the scrambling and modulation step. Then, the steps of layer mapping through mapping to resource elements is performed jointly.

In some implementations, the UE 202 can be configured to use the first mapping scheme when using the first transmission chain option. Further, the UE 202 can be configured to use the first or second mapping scheme when using the second transmission chain option. In some examples, whether the UE 202 uses the first or second mapping scheme further depends on RRC signaling and/or subject to UE capability. In some implementations, the UE 202 can be configured to use either of the transmission chain options (e.g., via higher layer signaling such as RRC) and/or either of the two mapping schemes in SDM and/or FDM-A with two codewords for transmission.

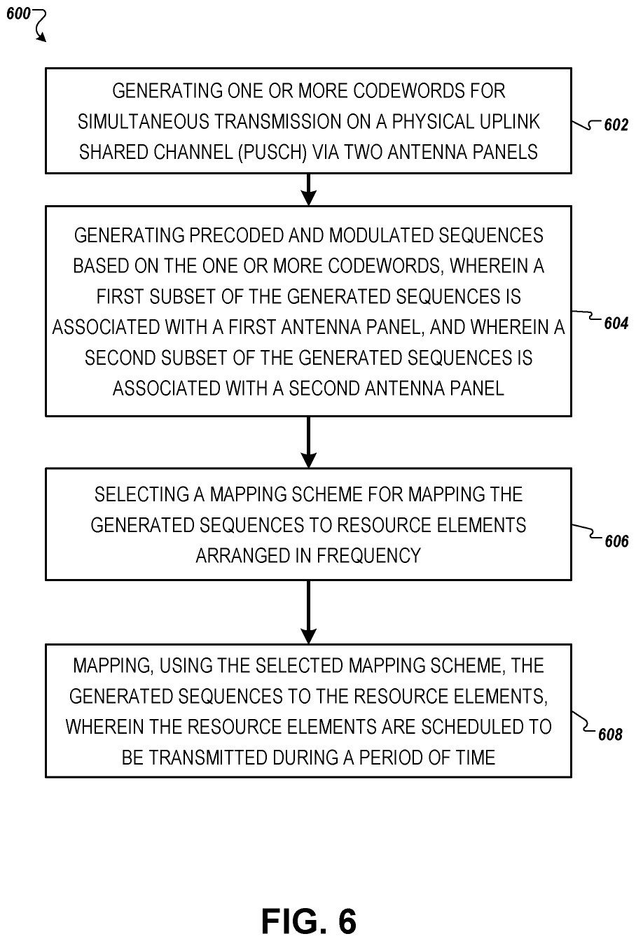

FIG. 6 illustrates a flowchart of an example method 600, according to some implementations. For clarity of presentation, the description that follows generally describes method 600 in the context of the other figures in this description. For example, method 600 can be performed by UE 202 of FIG. 2. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

At 602, method 600 involves generating one or more codewords for simultaneous transmission on a Physical Uplink Shared Channel (PUSCH) via two antenna panels.

At 604, method 600 involves generating precoded and modulated sequences based on the one or more codewords, where a first subset of the generated sequences is associated with a first antenna panel, and where a second subset of the generated sequences is associated with a second antenna panel.

At 606, method 600 involves selecting a mapping scheme for mapping the generated sequences to resource elements arranged in frequency.

At 608, method 600 involves mapping, using the selected mapping scheme, the generated sequences to the resource elements, where the resource elements are scheduled to be transmitted during a transmission period.

In some implementations, method 600 further involves transmitting, via the two antenna panels, the resource elements during the transmission period.

In some implementations, selecting the mapping scheme for mapping the generated sequences to resource elements arranged in frequency involves: selecting the mapping scheme from a first mapping scheme and a second mapping scheme, where: (i) the first mapping scheme maps the precoded/modulated sequences based on an antenna panel numbering, and (ii) the second mapping scheme the precoded/modulated sequences based on frequency.

In some implementations, the first mapping scheme involves: mapping the first subset of precoded/modulated sequences to a first subset of the resource elements; and subsequently mapping the second subset of precoded/modulated sequences to a second subset of the resource elements.

In some implementations, the second mapping scheme involves mapping the first subset of precoded/modulated sequences and the second subset of precoded/modulated sequences to the resource elements in order of frequency.

In some implementations, the one or more codewords are two codewords, and where selecting the first mapping scheme or the second mapping scheme involves determining that an indication of a number of layers is per codeword; and responsively selecting the first mapping scheme.

In some implementations, the one or more codewords are two codewords, and where selecting the first mapping scheme or the second mapping scheme involves determining that an indication of a number of layers is across the two codewords; and responsively selecting the second mapping scheme.

In some implementations, selecting the first mapping scheme or the second mapping scheme is based on at least one of higher layer signaling or UE capability.

In some implementations, the resource elements are non-overlapped frequency-division-multiplexed (FDM) resources.

In some implementations, the resource elements are spatially multiplexed across the two antenna panels.

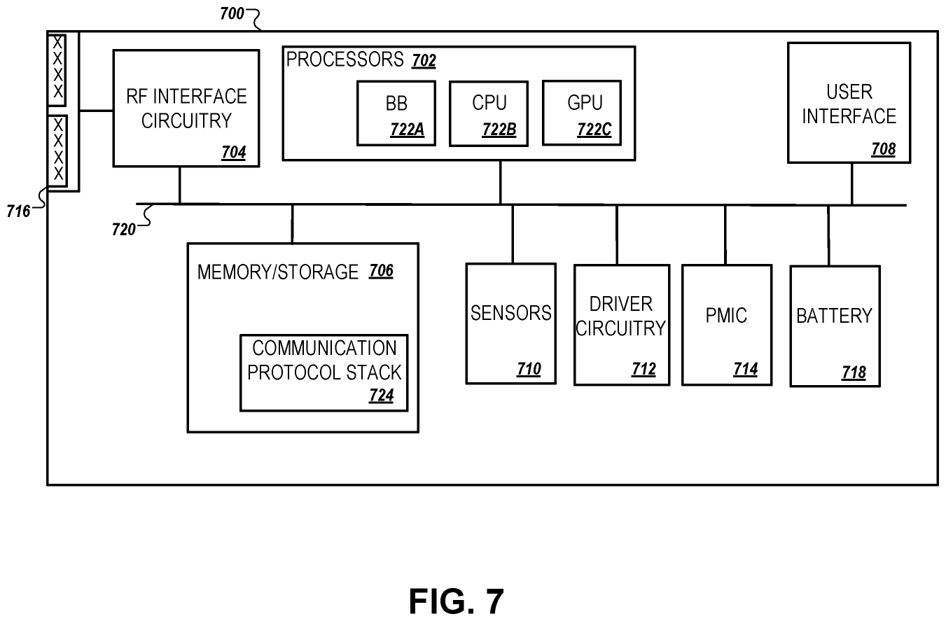

FIG. 7 illustrates a UE 700, according to some implementations. The UE 700 may be similar to and substantially interchangeable with UE 202 of FIG. 2.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, one or more antennas 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the processors 702 are configured to cause the UE to perform operations including generating one or more codewords for simultaneous transmission on a Physical Uplink Shared Channel (PUSCH) via two antenna panels; generating precoded/modulated sequences based on the one or more codewords, where a first subset of the sequences is associated with a first antenna panel, and where a second subset of the sequences is associated with a second antenna panel; selecting a first or a second mapping scheme for mapping the sequences to resource elements arranged in frequency, where: (i) the first mapping scheme maps the sequences based on an antenna panel numbering, and (ii) the second mapping scheme the sequences based on frequency; and mapping, using the first mapping scheme or the second mapping scheme, the sequences to the resource elements, where the resource elements are scheduled to be transmitted during a period of time.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

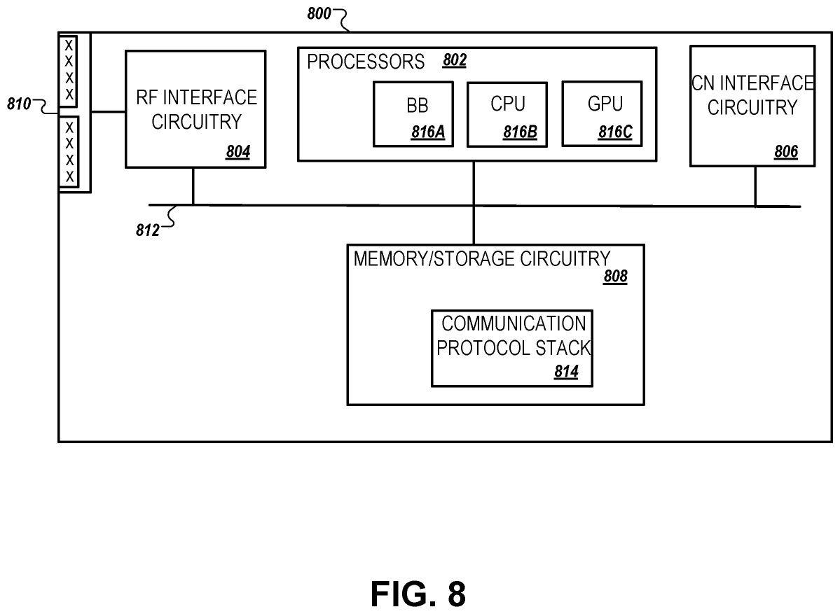

FIG. 8 illustrates an access node 800 (e.g., a base station, TRP, or gNB), according to some implementations. The access node 800 may be similar to and substantially interchangeable with base station 204. The access node 800 may include processors 802, RF interface circuitry 804, core network (CN) interface circuitry 806, memory/storage circuitry 808, and one or more antennas 810.

The components of the access node 800 may be coupled with various other components over one or more interconnects 812. The processors 802, RF interface circuitry 804, memory/storage circuitry 808 (including communication protocol stack 814), one or more antennas 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

In some implementations, as a TRP, the access node 800 is configured to receive one or more of the simultaneous multi-panel transmissions performed by a UE that is served by the access node 800. Additionally, the access node 800 is configured to signal to the UE which mapping scheme to select for the simultaneous multi-panel transmission. Further, the access node 800 is configured to signal to the UE which transmission chain option to select when processing multiple codewords for simultaneous transmission.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes one or more processors of a user equipment (UE), the one or more processors configured to cause the UE to perform operations including: generating one or more codewords for simultaneous transmission on a Physical Uplink Shared Channel (PUSCH) via two antenna panels; generating precoded and modulated sequences based on the one or more codewords, where a first subset of the generated sequences is associated with a first antenna panel, and where a second subset of the generated sequences is associated with a second antenna panel; selecting a mapping scheme for mapping the generated sequences to resource elements arranged in frequency; and mapping, using the selected mapping scheme, the generated sequences to the resource elements, where the resource elements are scheduled for transmission during a transmission period.

Example 2 is the one or more processors of Example 1, the operations further including transmitting, via the two antenna panels, the resource elements during the transmission period.

Example 3 is the one or more processors of any of Examples 1-2, where selecting the mapping scheme for mapping the generated sequences to resource elements arranged in frequency includes: selecting the mapping scheme from a first mapping scheme and a second mapping scheme, where: (i) the first mapping scheme maps the precoded and modulated sequences based on an antenna panel numbering, and (ii) the second mapping scheme the precoded and modulated sequences based on frequency.

Example 4 is the one or more processors of Example 3, where the first mapping scheme includes: mapping the first subset of precoded and modulated sequences to a first subset of the resource elements; and subsequently mapping the second subset of precoded and modulated sequences to a second subset of the resource elements.

Example 5 is the one or more processors of Example 3, where the second mapping scheme includes mapping the first subset of precoded and modulated sequences and the second subset of precoded and modulated sequences to the resource elements in order of frequency.

Example 6 is the one or more processors of any of Examples 1-5, where the one or more codewords are two codewords, and where selecting the first mapping scheme or the second mapping scheme includes: determining that an indication of a number of layers is per codeword; and responsively selecting the first mapping scheme.

Example 7 is the one or more processors of any of Examples 1-5, where the one or more codewords are two codewords, and where selecting the first mapping scheme or the second mapping scheme includes: determining that an indication of a number of layers is across the two codewords; and responsively selecting the second mapping scheme.

Example 8 is the one or more processors of any of Examples 1-5, where selecting the first mapping scheme or the second mapping scheme is based on at least one of higher layer signaling or UE capability.

Example 9 is the one or more processors of any of Examples 1-8, where the resource elements are non-overlapped frequency-division-multiplexed (FDM) resources.

Example 10 is the one or more processors of any of Examples 1-8, where the resource elements are spatially multiplexed across the two antenna panels.

Example 11 may include a non-transitory computer storage medium encoded with instructions that, when executed by one or more computers, cause the one or more computers to perform the operations of any of Examples 1 to 10.

Example 12 may include a system including one or more computers and one or more storage devices on which are stored instructions that are operable, when executed by the one or more computers, to cause the one or more computers to perform the operations of any of Examples 1 to 10.

Example 13 may include a method for performing the operations of any of Examples 1 to 10.

Example 14 may include an apparatus including logic, modules, or circuitry to perform one or more elements of the operations described in or related to any of Examples 1-10, or any other operations or process described herein.

Example 15 may include a method, technique, or process as described in or related to the operations of any of Examples 1-10, or portions or parts thereof.

Example 16 may include an apparatus, e.g., a user equipment, including: one or more processors and one or more computer-readable media including instructions that, when executed by the one or more processors, cause the one or more processors to perform the operations of any of Examples 1-10, or portions thereof.

Example 17 may include a computer program including instructions, where execution of the program by a processing element is to cause the processing element to carry out the method, techniques, or process as described in or related to the operations of any of Examples 1-10, or portions thereof. The operations or actions performed by the instructions executed by the processing element can include the operations of any one of Examples 1-10.

Example 18 may include a method of communicating in a wireless network as shown and described herein.

Example 19 may include a system for providing wireless communication as shown and described herein. The operations or actions performed by the system can include the operations of any one of Examples 1-10.

Example 20 may include a device for providing wireless communication as shown and described herein. The operations or actions performed by the device can include the operations of any one of Examples 1-10.

The previously-described operations of Examples 1-10 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to perform operations comprising:
generating one or more codewords for simultaneous transmission on a Physical Uplink Shared Channel (PUSCH) via two antenna panels;
generating precoded and modulated sequences based on the one or more codewords, wherein a first subset of the generated sequences is associated with a first antenna panel, and wherein a second subset of the generated sequences is associated with a second antenna panel;
selecting a mapping scheme for mapping the generated sequences to resource elements arranged in frequency; and
mapping, using the selected mapping scheme, the generated sequences to the resource elements, wherein the resource elements are scheduled for transmission during a transmission period.

2. The one or more processors of claim 1, the operations further comprising:
causing radio frequency (RF) circuitry to transmit, via the two antenna panels, the resource elements during the transmission period.

3. The one or more processors of claim 1, wherein selecting the mapping scheme for mapping the generated sequences to resource elements arranged in frequency comprises:
selecting the mapping scheme from a first mapping scheme and a second mapping scheme, wherein: (i) the first mapping scheme maps the precoded and modulated sequences based on an antenna panel numbering, and (ii) the second mapping scheme the precoded and modulated sequences based on frequency.

4. The one or more processors of claim 3, wherein the first mapping scheme comprises:
mapping the first subset of precoded and modulated sequences to a first subset of the resource elements; and
subsequently mapping the second subset of precoded and modulated sequences to a second subset of the resource elements.

5. The one or more processors of claim 3, wherein the second mapping scheme comprises:
mapping the first subset of precoded and modulated sequences and the second subset of precoded and modulated sequences to the resource elements in order of frequency.

6. The one or more processors of claim 1, wherein the one or more codewords are two codewords, and wherein selecting the first mapping scheme or the second mapping scheme comprises:
determining that an indication of a number of layers is per codeword; and
responsively selecting the first mapping scheme.

7. The one or more processors of claim 1, wherein the one or more codewords are two codewords, and wherein selecting the first mapping scheme or the second mapping scheme comprises:
determining that an indication of a number of layers is across the two codewords; and
responsively selecting the second mapping scheme.

8. The one or more processors of claim 1, wherein selecting the first mapping scheme or the second mapping scheme is based on at least one of higher layer signaling or UE capability.

9. The one or more processors of claim 1, wherein the resource elements are non-overlapped frequency-division-multiplexed (FDM) resources.

10. The one or more processors of claim 1, wherein the resource elements are spatially multiplexed across the two antenna panels.

11. (canceled)

12. A user equipment (UE) configured to perform operations comprising:
generating one or more codewords for simultaneous transmission on a Physical Uplink Shared Channel (PUSCH) via two antenna panels;
generating precoded and modulated sequences based on the one or more codewords, wherein a first subset of the generated sequences is associated with a first antenna panel, and wherein a second subset of the generated sequences is associated with a second antenna panel;
selecting a mapping scheme for mapping the generated sequences to resource elements arranged in frequency; and
mapping, using the selected mapping scheme, the generated sequences to the resource elements, wherein the resource elements are scheduled for transmission during a transmission period.

13. (canceled)

14. The UE of claim 12, the operations further comprising:
causing radio frequency (RF) circuitry to transmit, via the two antenna panels, the resource elements during the transmission period.

15. The UE of claim 12, wherein selecting the mapping scheme for mapping the generated sequences to resource elements arranged in frequency comprises:
selecting the mapping scheme from a first mapping scheme and a second mapping scheme, wherein: (i) the first mapping scheme maps the precoded and modulated sequences based on an antenna panel numbering, and (ii) the second mapping scheme the precoded and modulated sequences based on frequency.

16. The UE of claim 15, wherein the first mapping scheme comprises:
mapping the first subset of precoded and modulated sequences to a first subset of the resource elements; and
subsequently mapping the second subset of precoded and modulated sequences to a second subset of the resource elements.

17. The UE of claim 15, wherein the second mapping scheme comprises:
mapping the first subset of precoded and modulated sequences and the second subset of precoded and modulated sequences to the resource elements in order of frequency.

18. The UE of claim 12, wherein the one or more codewords are two codewords, and wherein selecting the first mapping scheme or the second mapping scheme comprises:
determining that an indication of a number of layers is per codeword; and
responsively selecting the first mapping scheme.

19. The UE of claim 12, wherein the one or more codewords are two codewords, and wherein selecting the first mapping scheme or the second mapping scheme comprises:
determining that an indication of a number of layers is across the two codewords; and
responsively selecting the second mapping scheme.

20. The UE of claim 12, wherein selecting the first mapping scheme or the second mapping scheme is based on at least one of higher layer signaling or UE capability.

21. A method comprising:
generating one or more codewords for simultaneous transmission on a Physical Uplink Shared Channel (PUSCH) via two antenna panels;
generating precoded and modulated sequences based on the one or more codewords, wherein a first subset of the generated sequences is associated with a first antenna panel, and wherein a second subset of the generated sequences is associated with a second antenna panel;
selecting a mapping scheme for mapping the generated sequences to resource elements arranged in frequency; and
mapping, using the selected mapping scheme, the generated sequences to the resource elements, wherein the resource elements are scheduled for transmission during a transmission period.

22. The method of claim 21, further comprising:
causing radio frequency (RF) circuitry to transmit, via the two antenna panels, the resource elements during the transmission period.
